(19) United States
(12) Patent Application Publication
(10) Pub. No.: US 2010/0109313 A1
(43) Pub. Date: May 6, 2010

(54) BINDING OF STACKED FLAT PARTS

(75) Inventor: Ferdinand FUCHS, Nuertingen (DE)

Correspondence Address: GREENBLUM & BERNSTEIN, P.L.C., 1950 ROLAND CLARKE PLACE, RESTON, VA, 20191, US

(73) Assignee: Kugler-Womako GmbH, Nuertingen (DE)

(21) Appl. No.: 12/579,119

(22) Filed: Oct. 14, 2009

(30) Foreign Application Priority Data
Oct. 17, 2008 (DE) 20 2008 013 909.0
Jun. 11, 2009 (DE) 10 2009 025 105.7

(51) Int. Cl. B42D 1/00; B42B 5/08; B42C 9/00

(52) U.S. Cl. 281/27.1; 412/7; 412/38; 412/37

(57) ABSTRACT

Method and apparatus for binding stacked flat parts provided with perforations. The method includes applying an adhesive to a predetermined area of fingers of an outer sheet, and inserting the fingers into the perforations by bending the fingers in a spiral manner.

### CROSS-REFERENCE TO RELATED APPLICATIONS

The present application claims priority under 35 U.S.C. §119(a) of German Patent Application No. 20 2008 013 909.0 filed Oct. 17, 2008 and of German Patent Application No. 10 2009 025 105.7 filed Jun. 11, 2009, the disclosures of which are expressly incorporated by reference herein in their entireties.

### BACKGROUND OF THE INVENTION

1. Field of the Invention

The invention relates to a method for the binding of stacked flat parts, in particular sheets of paper, provided with perforations. Furthermore, the invention relates to an apparatus for the binding of stacked flat parts, in particular sheets of paper, provided with perforations, as well as bound flat parts, in particular sheets of paper.

2. Discussion of Background Information

Blocks or stacked flat parts made of paper or the like, such as brochures, user's guides, calendars, notepads, etc., should they need to be opened, will be bound with a binding comb or the like.

Moreover, it is known that stacks of paper like writing or note pads using glue strips or wire combs or the like are bound together on one side.

For example, European Patent No. EP-B-0 704 322 describes a binding comb for holding together a stack of sheets, wherein the back part and fingers of the binding comb are disclosed as a single-layer, one-piece plastic binder, which is produced in an injection molding process.

Moreover, International Publication No. WO-A-2006/090644 discloses a multi-layer, one-piece paper comb binder with ring-like loops.

### SUMMARY OF THE INVENTION

Starting from this state of the art, the invention provides a simple and fixed binding of paper layers or respectively paper stacks. According to the invention, a non-mixed binding can be provided.

Accordingly, the invention is directed to a method for the binding of stacked flat parts, in particular sheets of paper. The flat parts are provided with several perforations for the receipt of fingers or respectively tongue-like sections of an outer sheet, and an outer sheet with several or respectively a plurality of fingers is provided and the fingers of the outer sheet are or will be provided in a predetermined area with an adhesive. The fingers are inserted into the perforations of the stacked flat parts such that the fingers will be or are bent as a loop in a spiral-like manner like a coiled roll, and a preferably adhesive-free area of each finger is brought into overlapping contact with an area of the respective finger provided with adhesive.

The invention is based on the idea that an outer sheet, e.g., a base sheet with integrated fingers or respectively binding tongues or the like are provided as single pieces, such that the binding tongues are arranged on one side of a base area of the base sheet. The base area of this outer sheet or respectively the base sheet or cover sheet thereby corresponds with this base area of the paper sheets or respectively flat parts to be joined. Due to the fact that the fingers or respectively the binding tongues are part of an outer sheet and protrude from the base area of the outer sheet at a right angle and parallel to each other. A single-substance outer sheet can be provided so that, for example, when the base area of the outer sheet is made of paper, the tongues or respectively binding fingers or loops or the like are also made of the same material, preferably cellulose, i.e., paper or cardboard.

In this case, no disassembling processes are to be executed for the recycling of a bound writing pad made only of paper, which are otherwise necessary for example in the case of a wire comb binder of a writing pad with a wire comb made of metal.

Within the framework of the invention, it is conceivable that other substances or respectively materials, such as plastic, can be used for the outer sheet with the fingers as well as for the flat parts. Again, the outer sheet with the fingers is made of a single substance. Also in this case, no disassembling processes are to be executed for the recycling of a bound writing pad e.g., made only of plastic, which are otherwise necessary for example in the case of a wire comb binder of a writing pad with a wire comb made of metal.

The fingers or respectively binding tongues preferably have the same material strength or respectively material thickness as the base area of the outer sheet. Within the framework of the invention, it is also possible that the fingers or binding tongues arranged on the outer sheet and the outer sheet have different thicknesses. Moreover, in another embodiment, the fingers can also have different thicknesses.

Moreover, another idea of the invention is based on the fact that during the formation of the binding, a loop binding, or a type of roll loop binding is designed on one side of the flat parts to be joined, since the fingers or respectively binding tongues of the outer sheet, which will be or are rolled up like a loop, are joined together in a contact area. In this overlapping contact area, the binding tongues or respectively the fingers of the outer sheet are designed like a single roll or respectively a multiple spiral-like rolling. A type of single loop or multiple loops, in particular double loop, is hereby created. A first outer area of the fingers, which is adhesive-free or provided with an adhesive, is thereby brought in overlapping contact with a second area of the respective finger provided with adhesive. In one embodiment, a reactivatable or respectively activatable adhesive is applied to the fingers on both sides of the outer sheet, preferably in advance.

According to the invention, a rolled-up loop binding, for example for calendars or for writing pads, is thus provided. The loop binding is made of the same material, for example paper or cardboard, as the material of the entire outer sheet or respectively base or cover sheet. In particular, this type of single-material binding as a comb binding or also as a multiple-loop binding is provided according to the requirements of the binding. Moreover, the comb binding or respectively loop binding can be an integral part of the outer sheet or respectively the base sheet or the cover sheet and can thus comprise one piece.

In an alternative solution, a method for the binding of stacked flat parts, in particular sheets of paper, is also suggested. The flat parts are provided with perforations for the receipt of fingers or respectively binding tongues of an outer sheet, such that an outer sheet with several fingers is provided and the preferably adhesive-free fingers of the outer sheet are inserted into the perforations of the stacked flat parts such that the fingers will be or are bent in a spiral manner like a rolled-up roll. One area of the fingers is brought in overlapping contact with another area, and the overlapping contact areas of the respective fingers are then permanently joined together, preferably by radiation energy and further preferably by the introduction of heat.

Within the framework of the invention, a non-detachable connection is a permanent and preferably wear-resistant connection, which is preferably not non-destructive in the case of the opening or respectively releasing of the connection.

During the loop formation in the above-noted method, i.e., during the insertion of the binding tongues into the perforations of the flat parts to be joined together and during the bending of the fingers or respectively binding tongues due to the already existing adhesive mass onto the respective fingers on the inside, areas of the fingers are joined together. In a further method according to the invention, the fingers, which are first inserted into the perforations of the flat parts to be joined together, are designed in an overlapping area in a loop-like or rolled-up manner, and the overlapping contact areas of the respective fingers are then joined together in an unreleasable or respectively permanent manner. It is for example conceivable that an additional material is inserted into the outer sheet or base or cover sheet material, which reacts in the contact area and hardens after the loop formation through application of microwaves, UV radiation or laser beams or IR radiation or respectively heat, as well as through ultrasound application or the like. Within the framework of the invention, a welding is also possible for the formation of an unreleasable loop binding. A stable loop binding or respectively binding for a writing or respectively note pad loop is hereby also provided.

In accordance with the invention, the binding loops or respectively fingers are arranged or respectively cut out on one side of the outer sheet, i.e. of the base sheet or of the cover sheet, wherein the length of the fingers for the bindings is measured such that a predetermined joint overlapping area is created during the formation of the binding loop, i.e. during the screwing of the fingers into the perforations of the flat parts. Through the cutting of the uncoiled fingers or respectively loop tongues, it is possible to create different loop diameters, wherein it is possible to bind paper layers with different thicknesses with one outer sheet with corresponding fingers.

Moreover, one embodiment of the method is characterized in that the outer sheet for the stacked flat parts is conveyed flat. During the conveyance of the outer sheet onto the fingers or respectively binding tongues of the outer sheet adhesive will be or is applied and the outer free ends of the fingers are inserted into the perforations of the flat parts, which are brought in contact with the areas of the fingers provided with adhesive under further conveyance of the outer sheet. The loop binding of the fingers is hereby fixed, and the formed loop is immobilized preferably with adhesive at the transition point, such that bound material or respectively flat parts of the stack are prevented from being removed from the formed loop, since a permanent and unreleasable connection is formed in the contact area of the rolled-up fingers or respectively binding tongues.

Furthermore, it is provided in accordance with an advantageous embodiment of the method that the adhesive is applied to the inside of the fingers of the outer sheet, in particular next to the base area of the outer sheet. In this way, the outer free ends of the fingers or respectively the end areas of the fingers are bent or curved into the perforations of the flat parts during the insertion process and are brought into contact with the adhesive area designed on the finger after the formation of a complete loop. It is particularly advantageous if a reactivatable adhesive is employed or respectively used as the adhesive. Potential adhesive contamination during the binding process is hereby advantageously prevented or respectively avoided.

In order to achieve a simple insertion of the fingers or respectively binding tongues of the outer sheet, it is also provided that the flat parts to be joined are or will be arranged pushed up against each other before production of the bound stack so that the perforations of the flat parts, preferably in cross-section, are arranged in a curved or semi-circular manner so that the perforations of the surface form a type of bent channel for the binding tongues.

Moreover, it is advantageous in an embodiment if adhesive is applied to the fingers in sections during a conveyance, preferably a linear conveyance, of the flat outer sheet before insertion of the fingers into the perforations of the flat parts. In particular, the adhesive is thereby applied to the inside of the fingers or respectively binding tongues of the outer sheet, which is assigned to the stacked or respectively bound flat parts after formation of the ring- or respectively loop-like binding. The adhesive is hereby applied in the root area of the fingers between the base area of the outer sheet and the outer free ends or respectively end sections of the fingers. The outer free ends or respectively end sections of the fingers, which are first inserted into the perforations, are adhesive-free.

In one embodiment, it is possible that the outer free ends or respectively the end sections of the fingers are coated with a reactivatable adhesive or respectively glue, which only reacts after the loop binding and through the application of energy, e.g., heat energy, and thereby first softens and then hardens to achieve an unreleasable connection of the formed loops. The reactivatable adhesive can thereby be applied to one or both sides of the fingers.

In a further embodiment, it is conceivable that the outer ends or respectively end sections of the fingers have a preferably included or integrated additive such as a sealer or the like, which only reacts after the loop binding and after a corresponding activation by the application of energy and thereby hardens in order to achieve an unreleasable connection of the formed loops.

Moreover, the method is characterized in that during the insertion of the fingers into the perforations of the flat parts the base area of the outer sheet, on which the fingers are arranged, and the stacked flat parts are or will be arranged tilted towards each other, whereby the loop formation or respectively the insertion of the fingers into the perforations is facilitated.

The invention is directed to an apparatus for the binding of stacked flat parts, in particular sheets of paper, with preferably metal-free binding elements. The flat parts are provided with perforations, which are further characterized in that a finger insertion device for the insertion of fingers of an outer sheet is provided for the flat parts such that the fingers are or will be bent in a spiral-like manner or respectively bent in a rolled up manner and an area of the fingers inserted into the perforations of the flat parts will be or is brought in overlapping contact with another area of the respective finger. A conveyor device for the conveyance of the outer sheet designed as one-piece with fingers is provided so that one outer sheet can be conveyed to the finger insertion device, and the finger insertion device is provided with a receiver for a stack of flat parts to be bound. The binding elements provided for the binding are thereby designed as a plurality of fingers or respectively binding tongues, which engage with the perforations of the flat parts or are brought to engage with the perforations. In particular, the binding means is designed as an outer sheet with fingers arranged on it.

When using the apparatus together with a stack of flat parts to be bound and an outer sheet with corresponding fingers or respectively binding tongues, it is possible to design a permanent binding of the flat parts.

Moreover, the apparatus is characterized in that a finger connecting device is arranged on the finger insertion device such that in particular the finger insertion device has a binding loop forming device and/or a guide shell. In this way, the overlapping contact areas of the rolled up fingers are joined together. A type of loop forming apparatus is hereby designed, such that the outer sheet is conveyed with the integrated fingers or respectively binding tongues and is curved into or inserted into the perforation of the flat parts by the finger insertion device. In particular, the binding loop forming device has one or several guide shells, wherein in one embodiment at least one guide shell is provided for each finger or a binding tongue of an outer sheet.

In one embodiment, the apparatus is also characterized in that an adhesive application device is arranged on the conveyor device so that adhesive can be applied to each area of the fingers of the outer sheet.

For this, it is also provided that the adhesive application device applies adhesive along the adhesive application device during the conveyance of the outer sheet.

Furthermore, one embodiment of the apparatus is characterized in that the conveyor device for the outer sheet is designed as a suction belt conveyor that can be supplied with negative pressure from a negative pressure source and/or has a cam belt and/or a suction belt feedboard.

The invention is also directed to bound flat parts, in particular sheets of paper. An outer sheet has several fingers, preferably arranged parallel and/or next to each other, and the fingers of an outer sheet are arranged in perforations of the stacked flat parts. The fingers are bent in a spiral-like manner or rolled (up) and one area of the fingers is brought in overlapping contact with another area of the respective finger, and the fingers are unreleasably joined together in the contact area of the fingers, which can be obtained through the execution of the method described above, in particular using an apparatus described above. Moreover, the above explanations for the method and for the apparatus are expressly referred to herein in order to avoid repetitions.

For this, it is also provided that the outer sheet and the fingers of the outer sheet are made essentially of the same non-metallic, single-layer material and/or essentially have the same thickness.

It is in particular beneficial when, in the case of the bound flat parts, the outer sheet and the fingers of the outer sheet and the flat parts are made or produced of the same material.

The invention is directed to a method for binding stacked flat parts provided with perforations. The method includes applying an adhesive to a predetermined area of fingers of an outer sheet, and inserting the fingers into the perforations by bending the fingers in a spiral manner.

According to embodiments of the invention, the flat parts can include sheets of paper, a portion of each finger may be adhesive free, and the bending of the fingers in a spiral manner can include overlapping the adhesive free portion and the predetermined area of the finger with applied adhesive.

In accordance with other embodiments of the present invention, the adhesive can be applied to the predetermined area of the fingers during the conveyance of the outer sheet, and outer free ends of the fingers may be inserted into the perforations and brought into contact with the predetermined areas of the fingers provided with adhesive as the outer sheet is further conveyed.

According to further embodiments, the predetermined area can be located on an inside of the fingers and next to a base area of the outer sheet.

Still further, before binding, the method can further include forming the perforations in the stacked flat parts into a curved channel.

According to other embodiments of the instant invention, the applying the adhesive may include applying adhesive to the fingers in sections during a linear conveyance of the outer sheet.

According to still other embodiments of the invention, during the inserting of the fingers, the stacked flat parts may be tilted with respect to a base area of the outer sheet.

The invention is directed to a method for binding stacked flat parts provided with perforations, in which the stacked flat parts include sheets of paper and the method includes inserting fingers of an outer sheet into the perforations by bending the fingers in a spiral manner to form a contact area in which one area of the fingers overlaps another area of the fingers, and permanently joining the areas in the contact area.

In accordance with embodiments of the instant invention, the fingers inserted into the perforations may be adhesive free, and the areas in the contact area can be permanently joined by radiation energy. Further, the areas in the contact may be permanently joined by heating.

The invention is directed to an apparatus for binding together stacked flat parts with at least one metal-free binding element, in which the flat parts include paper sheets and have perforations. The apparatus includes a finger insertion device structured and arranged to bend and insert fingers of an outer sheet into the perforations in a spiral manner such that an area of the fingers overlaps another area of respective fingers, and a conveyor structured and arranged to convey the outer sheet with fingers the finger insertion device. The finger insertion device has a receiver structured and arranged to receive a stack of flat parts to be bound together.

According to an embodiment of the invention, the apparatus may further include a finger connecting device arranged on the finger insertion device to join together the overlapping areas of the fingers. The finger insertion device can include at least one of a binding loop forming device and a guide shell.

In accordance with embodiments of the present invention, the apparatus can further include an adhesive application device arranged on the conveyor to apply adhesive to an area of the fingers. The adhesive application device can apply the adhesive to the area of the fingers during conveyance of the outer sheet.

According to other embodiments of the invention, the conveyor can include a suction belt conveyor that at least one of is supplied with negative pressure from a negative pressure source, has a cam tape, and has a suction tape feedboard.

In accordance with still other embodiments, bound flat parts are formed according to the above-described method. The bound flat parts include an outer sheet having several fingers bent in a spiral manner to extend through perforations in stacked flat parts. One area of the fingers overlapping another area of the fingers is unreleasably joined together in a contact area of the fingers.

According to embodiments, the stacked flat parts may include sheets of paper and the fingers can be arranged at least one of parallel and/or next to each other.

Further, the outer sheet and the fingers may be made essentially of a same non-metallic, single-layer material and essentially have a same thickness.

In accordance with still yet other embodiments of the present invention, the outer sheet and the fingers can be made or produced from a same material.

Further characteristics of the invention will become apparent from the description of the embodiments according to the invention together with the claims and the included drawings. Embodiments according to the invention can fulfill individual characteristics or a combination of several characteristics.

### BRIEF DESCRIPTION OF THE DRAWINGS

The invention is described below, without restricting the general intent of the invention, based on an exemplary embodiment, wherein we expressly refer to the figures with regard to the disclosure of all details according to the invention that are not explained in greater detail in the text. The drawings show in:

FIG. 1 schematically illustrates a lateral view of a binding apparatus for the production of bound sheets of paper;

FIG. 2 schematically illustrates a detailed view of the apparatus in one cut;

FIG. 3 schematically illustrates a working position of the binding apparatus;

FIGS. 4a and 4b schematically illustrate a simply screwed in or respectively produced binding loop;

FIGS. 5a and 5b schematically illustrate a double screwed in or respectively produced binding loop;

FIG. 6 schematically illustrates a part of the binding apparatus for removal of a bound paper stack;

FIG. 7 schematically illustrates another working position at the binding apparatus;

FIG. 8 a top view of the top of the binding apparatus with the loop forming device omitted;

FIG. 9 schematically illustrates a top view of a sheet of paper of a stack of paper to be bound; and

FIGS. 10a and 10b schematically illustrate a top view of an outer sheet or respectively base sheet with binding tongues with different lengths.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

In the following figures, the same or similar types of elements or respectively corresponding parts are provided with the same reference numbers in order to prevent the item from needing to be reintroduced.

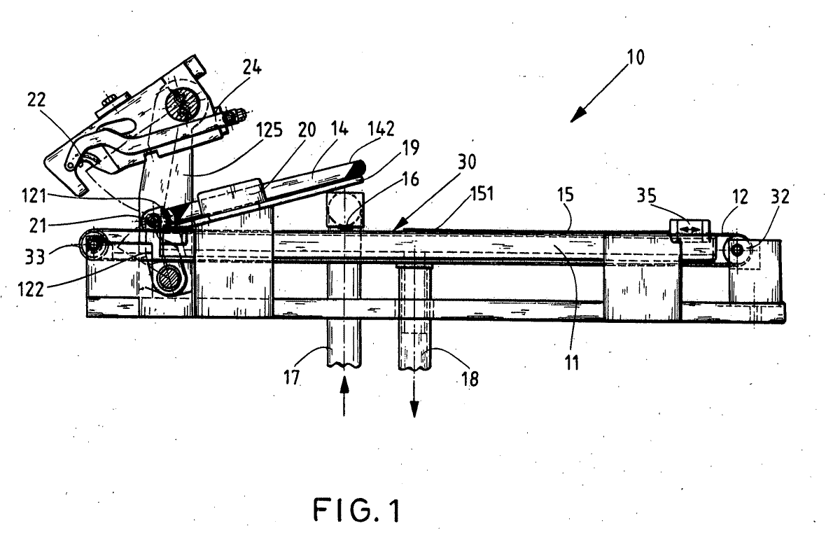

FIG. 1 shows a schematic view of the structure of a binding apparatus 10 for the binding of a stack 14 of several sheets of paper.

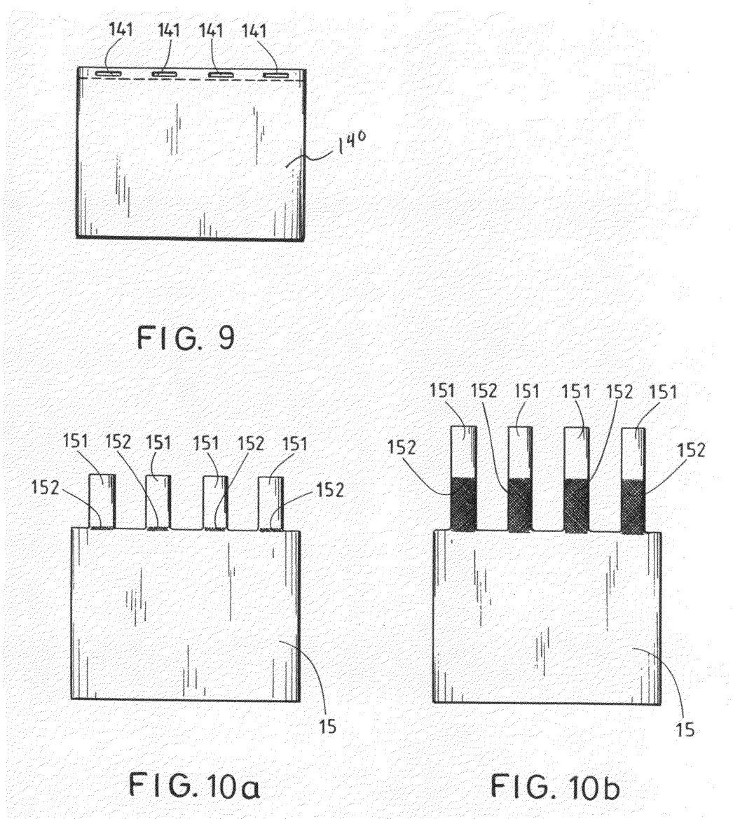

Stack 14 includes several sheets of paper, which are schematically shown from the top in FIG. 9. A sheet of paper 140 shown in FIG. 9 has a right-angle base area, and several perforation holes 141 are designed in the (upper) edge area. Perforation holes 141 are designed as drawn-out slits, such that a type of slit-like channel is formed through perforation holes 141 in the case of a block-wise arrangement or respectively stack-wise arrangement of several sheets of paper 140.

Stack 14 of sheets of paper shown schematically in FIG. 1 is arranged on a tilted supporting table 19 with a fitted cover sheet 142 on the top side.

A binding apparatus 10 has a horizontally aligned conveyor table 30, which is arranged below the supporting table 19. In order to position paper stack 14 together with cover sheet 142 on tilted supporting table 19, one or respectively more pivotable stack formers 21 is or are arranged on the bottom end of supporting table 19 with partially circular contact surfaces for paper stack 14, so that perforations 141 of paper stack 14 form a partially circular channel in cross-section.

Stack formers 21 have a nose-like protrusion 121 on the top side, to which a height or respectively thickness of paper stack 14 to be bound may be restricted. Stack formers 21 are arranged on a pivot arm 122 so that stack formers 21 can be pivoted down and away.

Moreover, supporting table 19 has corresponding lateral guide plates 20 located to act together with the stack formers 21 in order to exactly position paper stack 14, so that perforations 141 of paper stack 14 form the slit-like channels with a predetermined radius of curvature.

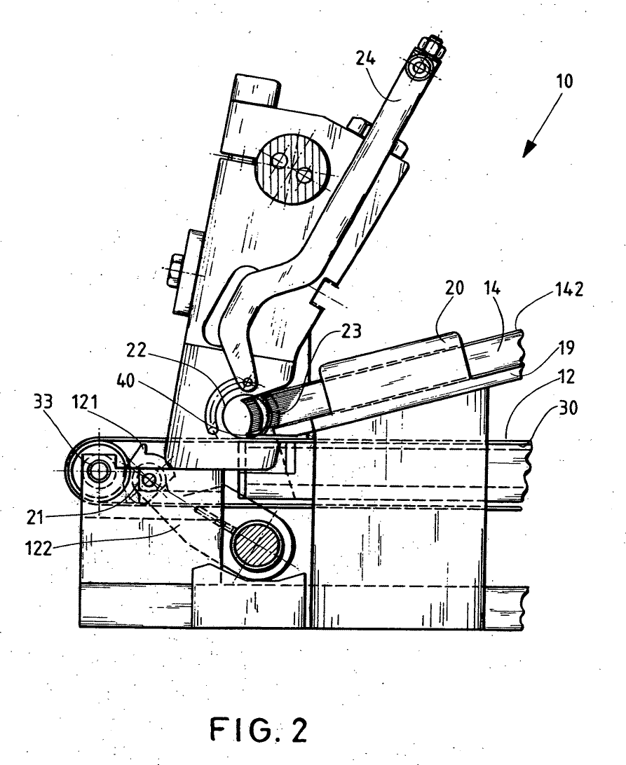

A binding loop forming device 22, which is arranged above the bottom end of the supporting table 19 or above stack formers 21, is designed in a pivotable manner on a support or frame arm 125. In FIG. 1, binding loop forming device 22 is shown in a pivoted up position, and can be pivoted over the frame point (see FIG. 2) until it is arranged concentrically with stack formers 21.

Moreover, conveyor table 30 of binding apparatus 10 has perforated suction belts 12, which are conveyed over outer rollers 32, 33. A suction plate 11 is arranged below suction belts 12 in order to supply suction belts 12 or respectively a base sheet 15 arranged on suction belts 12 with negative pressure via a negative pressure connection 18. Base sheet 15 is hereby arranged above or respectively on a suction belt 12, and a stop 35 is arranged to be moved with the suction belts 12. Stop 35, as depicted on the outer right edge of the suction belt 12 in FIG. 1, and can be moved back and forth on conveyor table 30 in order to move base sheet 15 on conveyor table 30.

FIGS. 10a and 10b both show different schematic views of a base sheet 15. Base sheets 15 have a rectangular base area like the sheets of paper (see FIG. 9, reference number 140), and the base area of base sheets 15 mainly corresponds with the base area of the sheets of paper 140 to be bound. Within the framework of the invention, it is also provided to process base sheets 15, which have a multi-side edge area protruding in particular on three sides.

As can be seen from FIGS. 10a, 10b, tongue-like fingers or respective binding tongues 151, which are arranged on a longitudinal side of each of the base sheets 15, are to be inserted into the perforations 141 of the sheets of paper 140. For this, binding tongues 151 are arranged at the spots where perforation holes 141 are designed in the sheet of paper 140.

In order to insert binding tongues 151 of base sheet 15 into the partially circularly designed channels of perforation holes 141 of stacked sheets 14 of paper, a base sheet 15 is arranged on each of the suction belts 12 of binding apparatus 10 according to FIG. 1. Initially, however, binding tongues 151 are not yet glued.

Using the binding apparatus 10 in FIG. 1, base sheets 15 are arranged such that binding tongues 151 are arranged on the side facing away from stop 35 so that binding tongues 151 point in the direction of supporting table 19 or respectively stack forming units 21.

Suction plate 11 is joined with a negative pressure source via a negative pressure connection 18 so that base sheet 15 is held on suction belts 12 through application of negative pressure.

In the case of a linear movement from left to right, as depicted in FIG. 1, binding tongues 151 are first conveyed under one or more glue nozzles 16 above conveyor table 30, so that binding tongues 151 are each provided with a trace of glue 152. The outer ends of binding tongues 151 are hereby not provided with glue or respectively with an adhesive, while the areas of bonding tongues 151 adjacent to the base area of base sheet 15 are provided with glue. The glue is conveyed to the glue nozzles 16 via a glue feed line 17.

Reference number 152 in FIGS. 10a, 10b shows the adhesive application areas or respectively glue traces 152 on binding tongues 151. The base area of base sheets 15 thereby remains adhesive- or respectively glue-free.

The length and the quantity of glue traces 152 on binding tongues 151 can depend on the length of binding tongues 151 and the preferred shape of the loops to be formed for the binding of paper stack 14.

FIG. 2 shows a detailed view of a working position of the binding loop forming device 22. Guide shells 23 are inserted into pre-punched perforations 141 or respectively the pre-punched binding slits of the sheets of paper 140 of stack 14 after the pivoting in of binding loop forming device 22 and the actuation of a control lever 24. Stack formers 21 can then pivoted down and away.

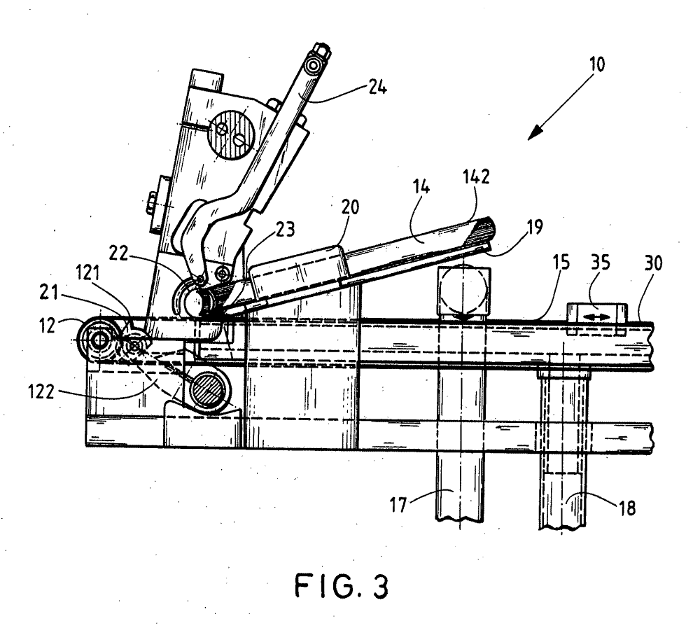

As shown in FIG. 2, a gap 40 is designed between a bottom side of supporting table 19 and suction belt 12 of conveyor table 30 or respectively between the ends of guide shells 23 and suction belt 12. Through this gap 40, base sheet 15 is guided with binding tongues 151. Each of the base sheets 15 arranged on suction belts 12 are conveyed in the direction of binding loop forming device 22 by moveable stop 35. At the beginning radius of guide shells 23 of binding loop forming device 22, the negative pressure on suction belts 12 will be or respectively is interrupted so that binding tongues 151 run into the circular guide shells 23 and are bent or rolled, as shown in FIG. 3.

Guide shells 23 take on the shape of the sheets of paper 140 of stack 14 on the outer radius during the formation of the loops and guide the inserted binding tongues 151 on the inner radius during the formation of the loops.

During the conveyance on suction belt 12, base sheet 15 is conveyed below glue nozzles 16 with its inside or respectively with its binding tongues 151 so that that binding tongues 151 are provided with a trace of glue 152 (see FIGS. 10a, 10b). A specified area of binding tongues 151 is hereby sprayed or respectively provided with a predetermined glue pattern in order to then be bent after insertion of binding tongues 151 into the channels formed by perforation holes 141 along guide shells 23. Under continuous transport of base sheet 15, the front ends of binding tongues 151 are conveyed by 360° on a circular track, so that the front ends of binding tongues 151 are brought into contact with glue track 152 applied on the inside of the binding tongues 151. In this manner, an unreleasable loop or a respective binding loop is formed.

FIG. 3 shows the working situation, in which base sheet 15 with the integrated binding tongues 151 on suction belts 12 is inserted into binding loop forming device 22. Due to the curvature of guide shells 23, binding tongues 151 lie against the inside of guide shells 23 and are thus inserted through the slit-like channel or respectively the slit-like channels, which is or are formed through the perforations of paper stack 14.

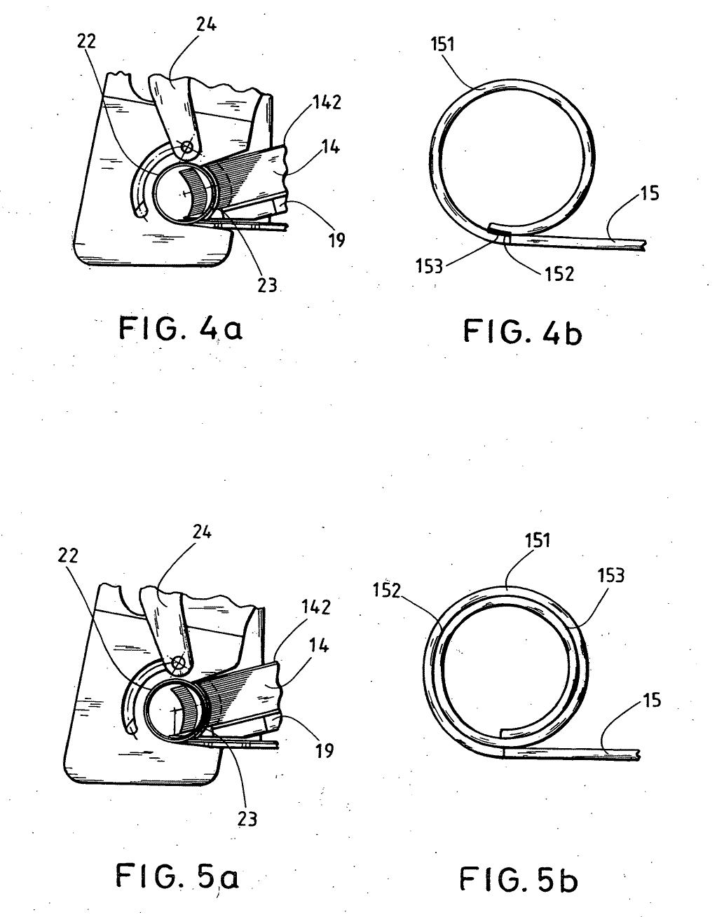

FIG. 4a shows schematically a single curved-in binding loop, which is shown enlarged in FIG. 4b with paper stack 14 omitted. As can be seen from FIG. 4b, the front end of binding tongue 151 is designed with glue trace 152 in an overlapping contact area 153.

FIG. 5a or respectively 5b show a schematic cross-section of a double curved-in or respectively designed binding loop. In the enlarged representation in accordance with FIG. 5b, paper stack 14 was also omitted for the sake of clarity. In the case of the binding loop formed in accordance with FIGS. 5a, 5b, the contact area or glue trace 152 is designed over a circumference of 360°. Depending on the material strength of base sheet 15 or binding tongues 151, the stability of the formed loops can be increased.

In the case of the double loop shown according to FIGS. 5a, 5b, the pivoted-in guide shells 23 can be pivoted back before the formation of the double loop, since an already created single loop takes over as the guide of the inner loop for the double loop. The binding loops produced according to the invention are designed with a spiral-like cross-section, and the contact area or respectively the length of the glue trace is selected or respectively predetermined according to the desired binding loop shape.

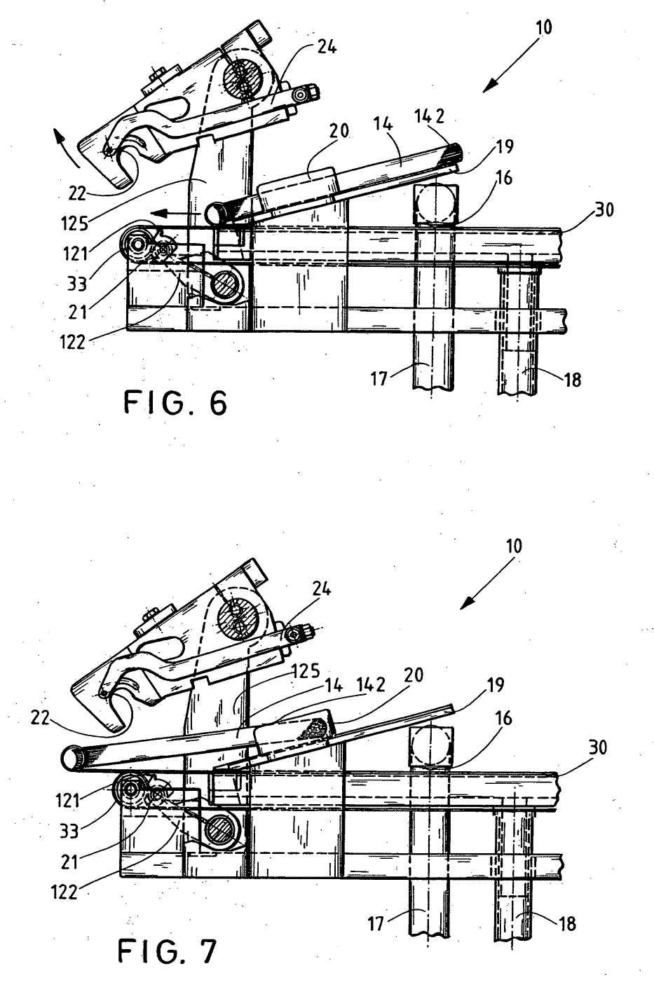

After the formation of a loop, binding loop forming device 22 is pivoted away as is shown schematically in FIG. 6. Bound paper stack 14, together with the loop formed by binding tongues 151 of base sheet 15, is then completely removed from binding apparatus 10, as schematically shown in FIG. 7.

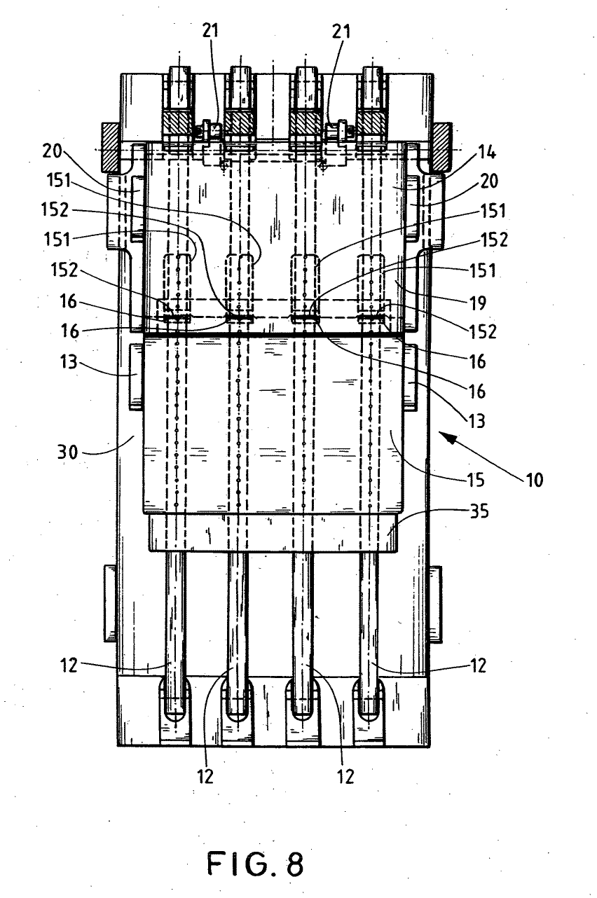

FIG. 8 shows a schematic top view of binding apparatus 10, in which the binding loop forming device has been omitted for the sake of clarity. As can be seen in FIG. 8, conveyor table 30 has lateral guide plates or guide rails 13 in order to ensure a secure positioning of base sheet 15 on suction tapes or belts.

FIG. 8 also shows a base sheet 15 having binding tongues 151 illustrated in dashed lines below supporting table 19. Moreover, glue nozzles 16, also illustrated in dashed lines, apply a trace of glue 152 (see FIG. 10a) in a root area of binding tongues 151.

As can be further seen from FIG. 8, stack formers 21 are arranged between suction belts 12 or guide shells 23 of binding loop forming device 22.

In accordance with the invention, pre-punched flat parts, such as sheets of paper, are bound with binding loops that are integrated in or respectively on the base sheet, cover sheet, or respective outer sheet. According to the described binding type, e.g., single loop or double loop, the lengths and the number of binding tongues on the base sheet or cover sheet are cut out and then shaped into a loop on the flat part stack to be bound by binding loop forming device 22 and screwed into the flat part stack.

Moreover, it is possible within the framework of the invention that the material for the base sheet or the cover sheet with the integrated binding tongues can include substances that, after formation of a binding loop and when exposed to a radiation source, reduce the flexibility of the material. In this manner, the state of the loop is retained and a firm writing pad or the like is simultaneously achieved.

Through the cutting of the binding tongues and the more or less curving or screwing into the binding loop, different loop diameters are created. In this way, different paper layer thicknesses can be bound with fewer cuts in the base or cover sheets. Furthermore, the formed binding loops on the transfer point are immobilized with adhesive after 360°, and the material bound by the binding loops or respectively the bound stack cannot be removed from the binding loop later on.

Furthermore, it is possible within the framework of the invention that the outer sheet, i.e., the base sheet or cover sheet, is designed in a rounded manner in particular at the spots that are formed for the binding loop. This creates a good gliding behavior through the loop former.

Moreover, it is possible within the framework of the invention that a magazine is provided on the binding apparatus for the base sheets or outer sheets, so that an automatic work process is achieved on the binding apparatus.

All named characteristics, including those taken from the drawings alone, and individual characteristics, which are disclosed in combination with other characteristics, are considered alone and in combination as important to the invention. Embodiments according to the invention can be fulfilled through individual characteristics or a combination of several characteristics.

### LIST OF REFERENCES

10 Binding apparatus

11 Suction plate

12 Suction belt

13 Guide plates

14 Stack

15 Base sheet

16 Glue nozzle

17 Glue feed line

18 Negative pressure connection

19 Supporting table

20 Guide plate

21 Stack formers

22 Binding loop forming device

23 Guide shell

24 Control lever

30 Conveyor table

32 Roll

33 Roll

35 Stop

40 Gap

121 Protrusion

122 Pivot arm

125 Support arm

140 Sheet of paper

141 Perforation holes

142 Cover Sheet

151 Binding tongues

152 Glue trace

What is claimed:

1. A method for binding stacked flat parts provided with perforations, comprising:
applying an adhesive to a predetermined area of fingers of an outer sheet; and
inserting the fingers into the perforations by bending the fingers in a spiral manner.

2. The method in accordance with claim 1, wherein the flat parts comprise sheets of paper, a portion of each finger is adhesive free, and the bending of the fingers in a spiral manner comprises overlapping the adhesive free portion and the predetermined area of the finger with applied adhesive.

3. The method in accordance with claim 1, wherein the adhesive is applied to the predetermined area of the fingers during the conveyance of the outer sheet, and
wherein outer free ends of the fingers are inserted into the perforations and brought into contact with the predetermined areas of the fingers provided with adhesive as the outer sheet is further conveyed.

4. The method in accordance with claim 1, wherein the predetermined area is located on an inside of the fingers and next to a base area of the outer sheet.

5. The method in accordance with claim 1, wherein, before binding, the method further comprises forming the perforations in the stacked flat parts into a curved channel.

6. The method in accordance with claim 1, wherein the applying the adhesive comprises applying adhesive to the fingers in sections during a linear conveyance of the outer sheet.

7. The method in accordance with claim 1, wherein, during the inserting of the fingers, the stacked flat parts are tilted with respect to a base area of the outer sheet.

8. A method for binding stacked flat parts provided with perforations, the stacked flat parts comprising sheets of paper and the method comprising:
inserting fingers of an outer sheet into the perforations by bending the fingers in a spiral manner to form a contact area in which one area of the fingers overlaps another area of the fingers; and
permanently joining the areas in the contact area.

9. The method in accordance with claim 8, wherein the fingers inserted into the perforations are adhesive free, and the areas in the contact area are permanently joined by radiation energy.

10. The method in accordance with claim 9, wherein the areas in the contact are permanently joined by heating.

11. An apparatus for binding together stacked flat parts with at least one metal-free binding element, the flat parts comprising paper sheet and having perforations, and the apparatus comprising:
a finger insertion device structured and arranged to bend and insert fingers of an outer sheet into the perforations in a spiral manner such that an area of the fingers overlaps another area of respective fingers;
a conveyor structured and arranged to convey the outer sheet with fingers the finger insertion device; and
the finger insertion device having a receiver structured and arranged to receive a stack of flat parts to be bound together.

12. The apparatus in accordance with claim 11, further comprising a finger connecting device arranged on the finger insertion device to join together the overlapping areas of the fingers, wherein the finger insertion device comprises at least one of a binding loop forming device and a guide shell.

13. The apparatus in accordance with claim 11, further comprising an adhesive application device arranged on the conveyor to apply adhesive to an area of the fingers.

14. The apparatus in accordance with claim 13, wherein the adhesive application device applies the adhesive to the area of the fingers during conveyance of the outer sheet.

15. The apparatus in accordance with claim 11, wherein the conveyor comprises a suction belt conveyor that at least one of is supplied with negative pressure from a negative pressure source, has a cam tape, and has a suction tape feedboard.

16. Bound flat parts formed according to the method of claim 1, comprising:
an outer sheet having several fingers bent in a spiral manner to extend through perforations in stacked flat parts;
wherein one area of the fingers overlapping another area of the fingers is unreleasably joined together in a contact area of the fingers.

17. The bound flat parts in accordance with claim 16, wherein the stacked flat parts comprise sheets of paper and the fingers are arranged at least one of parallel and/or next to each other.

18. The bound flat parts in accordance with claim 16, wherein the outer sheet and the fingers are made essentially of a same non-metallic, single-layer material that essentially have a same thickness.

19. The bound flat parts in accordance with claim 16, wherein the outer sheet and the fingers are made or produced from a same material.
